(19) United States
(12) Patent Application Publication
(10) Pub. No.: US 2026/0300657 A1
(43) Pub. Date: Oct. 1, 2026

(54) RADIO FREQUENCY IDENTIFICATION SYSTEM AND SIGNAL PROCESSING METHOD THEREOF, AND STORAGE MEDIUM

(71) Applicant: COMBA NETWORK SYSTEMS COMPANY LIMITED, Guangzhou (CN)

(72) Inventors: Zhongjun LIU, Guangzhou (CN); Baoguo DING, Guangzhou (CN); Wei ZHANG, Guangzhou (CN); Jun LI, Guangzhou (CN); Bo YANG, Guangzhou (CN); Jitao YU, Guangzhou (CN); Liusheng ZHONG, Guangzhou (CN)

(21) Appl. No.: 18/996,465

(22) PCT Filed: Dec. 15, 2023
(86) PCT No.: PCT/CN2023/139140

§ 371 Date: Jan. 17, 2025

(30) Foreign Application Priority Data
Aug. 7, 2023 (CN) 202310990968.2

(51) Int. Cl. G06K 7/10

(52) U.S. Cl. CPC G06K 7/10366

(57) ABSTRACT

A radio frequency identification system, a signal processing method and a storage medium are provided. The radio frequency identification system includes: a host computer, a reader, a first communication device, an RF exciter, and an RFID tag. The host computer is configured to obtain a current working state of the reader, and when the current working state is active, configure physical addresses and IP addresses for both of the reader and the RF exciter and enable a wired networking mode between the reader and the RF exciter. The reader is configured to transmit forward carrier signal to the RF exciter via network switching device The RF exciter is configured to transmit the forward carrier signal through the air interface. The RFID tag is configured to modulate the forward carrier signal to generate reverse transmission signal and transmit the reverse transmission signal to the reader through the air interface.

### CROSS-REFERENCE TO RELATED APPLICATIONS

### TECHNICAL FIELD

This application is a U.S. National Stage Application, filed under 35 U.S.C. 371, of International Patent Application No. PCT/CN 2023/139140, filed on Dec. 15, 2023, which claims priority to Chinese Patent Application No. 202310990968.2, filed with CNIPA on Aug. 7, 2023 and entitled “RADIO FREQUENCY IDENTIFICATION SYSTEM AND SIGNAL PROCESSING METHOD THEREOF, AND STORAGE MEDIUM”, the entire contents of which are incorporated herein by reference.

### TECHNICAL FIELD

The present disclosure relates to the technical field of communications, and in particular, to a radio frequency identification system and a signal processing method thereof, and a storage medium.

### BACKGROUND

Ultra High Frequency (UHF) Radio Frequency Identification (RFID) technology is characterized by its ability to read multiple tags simultaneously, strong penetration, the capability for repeated reading and writing, and large data storage capacity. Passive tags associated with UHF RFID technology are known for their low cost, small size, easy of use, high reliability and long service life. As a result, UHF RFID technology has found increasing applications across a wide range of fields and industries.

Currently, in UHF RFID system, both fixed and mobile readers are commonly used. For each type of reader, the RF transmission link and the RF reception link coexist within the device. Due to the size limitations of the device, the isolation between the RF transmission link and the RF reception link is relatively low, resulting in poor receiver sensitivity of the reader. This, in turn, restricts the coverage range of the UHF RFID system.

### SUMMARY

The technical problem to be solved by the present disclosure is to address the issue of low isolation between the radio frequency transmission link and the radio frequency reception link of the existing reader used in the UHF RFID system. This low isolation leads to poor receiver sensitivity of the reader, which in turn limits the coverage range of the UHF RFID system.

To solve the aforementioned technical problems, embodiments of the present disclosure provide a radio frequency identification system and a signal processing method thereof and a storage medium.

A radio frequency identification system includes a host computer, a reader, a first communication device, a radio frequency (RF) exciter, and a radio frequency identification (RFID) tag, the host computer communicating with the reader, the reader and the RF exciter performing information interaction via the first communication device;
the host computer is configured to: obtain a current working state of the reader, and when the current working state is active, configure physical addresses and IP addresses for both of the reader and the RF exciter, and enable a wired networking mode between the reader and the RF exciter;
the reader is configured to transmit a forward carrier signal to the RF exciter via a network switching device of the first communication device upon enablement of the wired networking mode;
the RF exciter is configured to transmit the forward carrier signal through the air interface; and the RFID tag is configured to modulate the forward carrier signal to generate a reverse transmission signal upon reception of the forward carrier signal and transmit the reverse transmission signal to the reader through the air interface.

A signal processing method, applied to the radio frequency identification system, includes:
obtaining, by the host computer, the current working state of the reader;
when the current working state is active, configuring, by the host computer, the physical addresses and the IP addresses for both of the reader and an RF exciter associated with the reader;
enabling the wired networking mode between the reader and the RF exciter by the host computer, to enable the reader to transmit the forward carrier signal to the RF exciter via the network switching device of the first communication device;
transmitting, by the RF exciter, the forward carrier signal through the air interface; and
upon reception of the forward carrier signal, modulating, by the RFID tag, the forward carrier signal to generate the reverse transmission signal, and transmitting, by the RFID tag, the reverse transmission signal to the reader through the air interface.

A computer-readable storage medium is provided, which stores computer-executable instructions thereon. The computer-executable instructions, when executed by a processor, implement steps of the signal processing method according to any embodiment of the present disclosure.

A computer program product is provided, including a computer program. The computer program, when executed by a processor, implements steps of the signal processing method according to any embodiment of the present disclosure.

Details of one or more embodiments of the present disclosure are set forth in the accompanying drawings and description below. Other features and advantages of the present disclosure may become apparent from the specification, the accompanying drawings, and the claims.

### BRIEF DESCRIPTION OF THE DRAWINGS

FIG. 1 illustrates a schematic structural diagram of a radio frequency identification system according to an embodiment of the present disclosure;

FIG. 2 illustrates a schematic structural diagram of another radio frequency identification system according to an embodiment of the present disclosure;

FIG. 3 illustrates a schematic structural diagram of further another radio frequency identification system according to an embodiment of the present disclosure;

FIG. 4 illustrates a schematic structural diagram of still another radio frequency identification system according to an embodiment of the present disclosure;

FIG. 5 illustrates a schematic structural diagram of yet another radio frequency identification system according to an embodiment of the present disclosure;

FIG. 6 is a schematic diagram that different RF exciters transmit forward carrier signals at distinct frequencies;

FIG. 7 illustrates a schematic structural diagram of a radio frequency identification system according to a specific embodiment of the present disclosure;

FIG. 8 illustrates a schematic structural diagram of another radio frequency identification system according to a specific embodiment of the present disclosure;

FIG. 9 is a schematic flowchart of a signal processing method according to an embodiment of the present disclosure; and FIG. 10 is a schematic flowchart of another signal processing method according to an embodiment of the present disclosure.

### DETAILED DESCRIPTION OF THE EMBODIMENTS

With continuous expansion of fields and industries in which UHF RFID is applied, the market demand for long-range UHF RFID system with a working distance of greater than 50 meters is becoming increasingly urgent. Improving the working distance of UHF RFID system requires that a reader in the UHF RFID system has relatively high receiver sensitivity. Additionally, in order to promote large-scale application of UHF RFID system, it is necessary to further reduce the cost, power consumption and size of the reader. Furthermore, with the development of passive Internet of Things, efficient networking among readers in UHF RFID system to enhance inventory management efficiency has also become a new requirement for UHF RFID system.

In existing UHF RFID systems, common readers include fixed readers and mobile readers. For each of these two types of readers, the RF transmission link and the RF reception link coexist in the device. The advantage of the reader is that the RF transmission link and the RF reception link share a clock source, which can eliminate the carrier signal via self-interference cancellation technology. Additionally, since the transmission link and the reception link coexist in the reader, the size of the reader is reduced to some extent. However, due to the size limitation of the reader, the isolation between the RF transmission link and the RF reception link is relatively low. It becomes challenging to fully eliminate the interference using self-interference cancellation technology when the power of the carrier signal is relatively large. This residual interference affects the receiver sensitivity of the reader, thereby limiting the working distance of the UHF RFID system.

There are also some UHF RFID systems that utilize dedicated reader chips for building readers, and the reader dedicated chip uses a switch based time-division multiplexing approach to alternate between the RF transmission link and the RF reception link, so as to achieve the separation of the RF transmission link and the RF reception link. However, with the time-division usage of the RF transmission link and the RF reception link, the dedicated reader chip can not transmit carrier signal while the reception link is receiving the tag signal. Additionally, this switching mechanism can introduce frequency offsets between the transmission link and the reception link. Furthermore, existing dedicated reader chips lack the capability to eliminate interference from non-coherent carrier signals, leading to interference from the carrier signal which reduces the receiver sensitivity. As a result, these dedicated reader chips have limited receiver sensitivity and are unable to achieve long-distance reception.

To address aforementioned issues, the present disclosure provides a radio frequency identification (RFID) system. The system utilizes an RF exciter to forward a forward carrier signal transmitted by a reader. The transmitter of the forward carrier signals is separated from receiver of the reverse transmission signal. The system reduces the interference between the forward carrier signal and the reverse transmission signals received by the reader from the RFID tag, thereby improving the receiver sensitivity of the reader. In the scheme of the present disclosure, a host computer obtains the current working state of the reader. If the state is determined to be active, the host computer configures physical addresses and IP addresses for both the reader and the RF exciter, and enables a wired networking mode between the reader and the RF exciter. So that the reader and the RF exciter can transmit signals through the network switching device of the first communication device. Compared with a wireless networking mode for signal transmission between the reader and the RF exciter, utilizing a wired connection via a network switching device results in superior signal demodulation quality and reduces susceptibility to the interference of the wireless channel environment. Moreover, by leveraging existing switch networks in actual deployment environment, signal transmission between the reader and the RF exciter can be achieved at a lower system deployment cost. Utilizing the network switching device for this purpose not only reduces costs but also provides the following beneficial effects.
(1) Compared with the existing solutions that rely on wireless networking for signal transmission between the reader and the RF exciter, the present scheme uses network switching device to establish wired networking between them, which offers in superior signal demodulation quality for interactive information and reduces susceptibility to the interference of the wireless channel environment. In addition, at present, 840~845 Mhz frequency band is currently subject to regulatory restrictions, limiting the available wireless frequency resources for communication between readers and RF exciters. Adopting a wired networking approach circumvents the limitations. Furthermore, when the reader needs to forward signals to multiple RF exciters simultaneously by using different frequency points, the wired networking approach reduces the signal interference, ensuring more reliable and stable information transmitted between readers and RF exciters.
(2) Adopting network switching device for wired networking not only supports Power over Ethernet (POE) for the RF exciter, but also facilitates rapid network setup. This approach significantly reduces the deployment effort required for powering the RF exciters and minimizing engineering work.
(3) In existing wireless networking solutions for communication between readers and exciters, the modulation time interval for configuring Pulse Interval Encoding (PIE) signals in RFID systems is typically set between 6.25 us~25 us. Due to different configurations of the modulation different configurations of intervals, and considering the time required for digital signal demodulation processing, the latency for the RF exciter to receive and demodulate the forward link signal from the reader often exceeds 10 us. By contrast, the present scheme leverages the network switching device to establish a wired networking connection between the reader and the RF exciter, utilizing wired TCP-IP packets transmission for signaling. This approach guarantees that the latency remains below 10 us, which effectively solves the high-latency issues inherent in the existing wireless transmission approach. Consequently, it better meets the latency requirements for the RF exciter to forward signals from the reader.
(4) Adopting network switching device to realize wired networking can better accommodates the transmission scenarios requiring large data volume and less stringent real-time requirements between the reader and the RF exciter. For example, when software upgrades from the reader to the RF exciter, the wired approach can more effectively and reliably transmit large software upgrade packages than in wireless scenario.

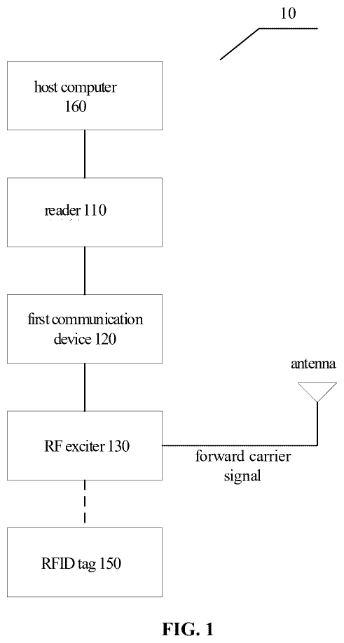

FIG. 1 is a schematic structural diagram of a radio frequency identification system provided in an embodiment of the present disclosure. As shown in FIG. 1, the radio frequency identification system 10 includes a host computer 160, a reader 110, a first communication device 120, an RF exciter 130, and an RFID tag 150. The host computer 160 communicates with the reader 110 via either wireless or wired communication, with no specific restrictions imposed by this disclosure on the communication method. The reader 110 and the RF exciter 130 perform information interaction via the first communication device 120. Dotted line in FIG. 1 indicates messages transmitted through the air interface.

The RF exciter 130 can be a digital demodulate-and-amplify-and-forward RF exciter, including following units: an Analog-to-Digital converter (AD), a Field Programmable Gate Array (FPGA), a Digital-to-Analog converter (DA), and a Power Amplifier (PA); alternatively, the RF exciter 130 can also be an analog amplify-and-forward RF exciter, including an analog signal amplification unit.

In the embodiment of the present disclosure, the host computer 160 obtains a current working state of a network interface card (NIC) in the reader 110. When the current working state is active, the host computer 160 configures physical addresses, i.e., Media Access Control (MAC) Addresses and IP addresses for both the reader 110 and the RF exciter 130, and enables a wired networking mode between the reader 110 and the RF exciter 130. Upon activation of the wired networking mode, the reader 110 transmits a forward carrier signal to the RF exciter 130 via a network switching device of the first communication device 120. The network switching device can be, for example, a switch, a hub, and the like. After receiving the forward carrier signal, the RF exciter 130 transmits the forward carrier signal via the air interface through its antenna. It can be understood that the reader 110 and the RF exciter 130 transmit signals via the network switching device based on the configured MAC addresses and IP addresses. In response to the received forward carrier signal, the RFID tag 150 modulates the forward carrier signal to generate a reverse transmission signal, which can carry bit information including, but not limited to, product codes, sensor data, environmental data, etc. The RFID tag 150 then transmits the generated reverse transmission signal back to the reader 110 through the air interface. The reader 110 demodulates and stores the carried bit information in the reverse transmission signal, thereby completing inventory of the RFID tag 150.

Specifically, the forward carrier signal can be, but is not limited to, a single tone carrier signal, a narrowband constant envelope phase modulation signal, or a wideband phase/frequency modulation signal.

In the embodiment of the present disclosure, the reader 110 and the RF exciter 130 perform information interaction via the network switching device of the first communication device 120. Compared with wireless communication methods, the wired communication approach using the network switching device of the first communication device 120 enables the reader 110 to transmit a forward carrier signal at relatively low power to the RF exciter 130, which reduces the power required for signal transmission by the reader 110.

In the embodiment of the present disclosure, the first communication device 120 includes at least a network switching device to facilitate a wired networking between the reader 110 and the RF exciter 130. Consequently, the reader 110 is enabled to transmit the forward carrier signal to the RF exciter 130 via a wired network. The reader 110 can also transmit broadcast messages and synchronization messages to the RF exciter 130 based on TCP-IP packets, and receive acknowledgement messages, access request messages, etc., replied by the RF exciter 130 based on TCP-IP packets. In a case where the reader 110 sends messages to the RF exciter 130 using TCP-IP packets, the reader 110 can send control messages instructing the RF exciter 130 to transmit the forward carrier signal. The control messages can carry information such as the transmission period and frequency of the forward carrier signal. The RF exciter 130, upon receiving these control messages, generates and transmits the forward carrier signal in accordance with the specified period and frequency, eliminating the need for the reader 110 to continuously send the forward carrier signal to the RF exciter 130.

In the embodiment of the present disclosure, an IP address allocation of the RF exciter 130 managed by the reader 110 supports both Dynamic Host Configuration Protocol (DHCP) and manual static configuration. The association between the reader 110 and the RF exciter 130 can be established by binding their Serial Numbers (SNs). This process of binding is performed by the host computer 160. Specifically, the host computer 160 can obtain the SNs of the reader 110 and the RF exciter 130 either through manual input or automatic reading methods. After obtaining the SNs of the reader 110 and the RF exciter 130, the host computer 160 binds the SN of the reader 110 and the SN of the RF exciter 130 that needs to be managed by the reader 110, for example, can be bound using a format like “Reader SN+Exciter SN”. One reader 110 may manage multiple RF exciters 130; forming a one-to-many relationship between the reader's SN and the RF exciters' SNs. In practice applications, one reader 110 can manage up to 32 RF exciters 130. The networking between the reader 110 and the group of RF exciters it manages can be configured using either single-tier or dual-tier network switching devices.

It should be noted that in embodiments of the present disclosure, the reader 110 can interact with multiple RF exciters 130 via the first communication device 120, and typically, there are multiple RFID tags 150 in the environment. FIG. 1 merely explains the present disclosure by illustrating one RF exciter 130 and one RFID tag 150 as an example, which should not be construed as a limitation of the present disclosure.

In the radio frequency identification system of the embodiment of the present disclosure, the host computer obtains the current working state of the reader, configures the physical addresses and IP addresses of the reader and the RF exciter in the case where the obtained current working state is active, and enables the wired networking mode between the reader and the RF exciter, so that the reader and the RF exciter are able to transmit signals via the network switching device of the first communication device. Compared to wireless networking scheme for signal transmission between the reader and the RF exciter, using a wired connection through the network switching device offers superior signal demodulation quality, minimizing interference from wireless channel environments. Additionally, signal transmission between the reader and the RF exciter can be realized by utilizing the network switching device already existing in actual environment, reducing the deployment cost of the system. In the present solution, after the wired networking mode between the reader and the RF exciter is enabled, the reader sends the forward carrier signal to the RF exciter via the network switching device of the first communication device. The RF exciter forwards the forward carrier signal through the air interface. The RFID tag, in reception of the forward carrier signal, modulates the forward carrier signal to generate the reverse transmission signal. The RFID tag further transmits the reverse transmission signal to the reader through the air interface. With the solution of the present disclosure, the RF exciter is utilized to forward the forward carrier signal from the reader. As a result, the transmitter of the forward carrier signal is separated from the receiver of the reverse transmission signal. In this way, the interference between the forward carrier signal and the reverse transmission signal received by the reader from the RFID tag is reduced, which improves the receiver sensitivity of the reader.

In an optional embodiment of the present disclosure, the host computer 160 is further used to enable a wireless networking mode between the reader 110 and the RF exciter 130 when the current working state is inactive. In response to the activation of the wireless networking mode, the reader 110 is further used to transmit a forward carrier signal to the RF exciter 130 via a power divider and a coupler of the first communication device 120, and the RF exciter 130, upon receiving the forward carrier signal, transmits it through the air interface. In response to receiving the forward carrier signal, the RFID tag 150 modulates it to generate a reverse transmission signal, which can carry bit information including, but not limited to, product codes, sensor data, environmental data, and the like. Subsequently, the RFID tag 150 then transmits the generated reverse transmission signal back to the reader 110 through the air interface, so that the reader 110 can demodulate and store the carried bit information in the reverse transmission signal, thereby completing inventory process for the RFID tag 150.

In the embodiment, the first communication device 120 further includes the power divider and the coupler. These components enable the reader 110 to transmit control messages such as broadcast messages, synchronization messages to the RF exciter 130 based on RF signals, to receive acknowledgement messages, access request messages, etc., from the RF exciter 130 also based on RF signals, and to receive coupled signals sent to the reader 110 by a coupling network. The reader 110 sends the forward carrier signal based on an RF signal to the power divider and coupler of the first communication device 120, and the power divider and coupler of the first communication device 120 forwards the forward carrier signal to the RF exciter 130. In this communication method, it is required that the reader 110 continuously transmits forward carrier signals to the RF exciter 130.

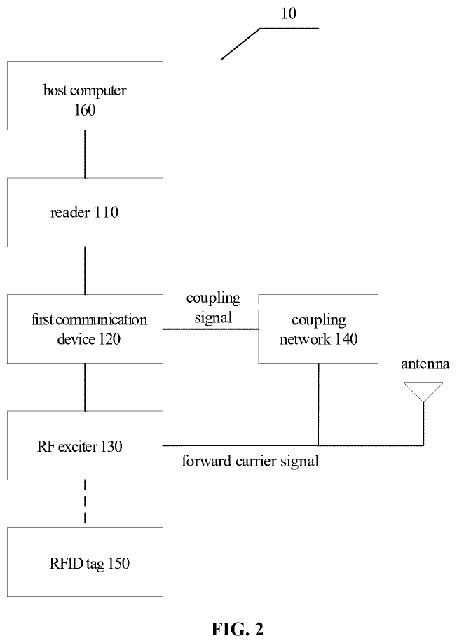

It can be understood that since the RF exciter 130 transmits the forward carrier signal through the air interface in an omnidirectional manner rather than targeting it specifically at the RFID tag 150, not only the RFID tag 150 can receive the forward carrier signal transmitted by the RF exciter 130, but also the reader 110 can receive the forward carrier signal transmitted by the RF exciter 130 through the air interface. This means that the air interface signal received by the reader 110 through the air interface includes both the forward carrier signal from the RF exciter 130 and the reverse transmission signal from the RFID tag 150. The forward carrier signal from the RF exciter 130 can interfere with the reader 110's reception of the reverse transmission signals from the RFID tag 150 through the air interface, potentially degrading the reader 110's ability to accurately identify and process these signals. In view of this, in an optional embodiment of the present disclosure, on the basis of the embodiment shown in FIG. 1, as shown in FIG. 2, the radio frequency identification system 10 further includes a coupling network 140. The RF exciter 130, after receiving the forward carrier signal, not only transmits the forward carrier signal through the air interface, but also transmits the forward carrier signal to the coupling network 140. The coupling network 140 couples the forward carrier signal from the RF exciter 130 to generate a coupled signal. The coupling network 140 and the reader 110 are connected via the first communication device 120, and the generated coupled signal is transmitted to the reader 110 via the power divider and coupler of the first communication device 120. Upon receiving the coupled signal, the reader 110 uses the received coupled signal to eliminate interference caused by the forward carrier signal in the air interface signals it receives, thereby mitigating the interference with the reverse transmission signal.

The coupling network 140 generates the coupled signal based on the forward carrier signal. For example, it can use the forward carrier signal directly as the coupled signal, ensuring that the coupled signal does not contain additional noise other than the forward carrier signal. Consequently, the coupled signal is used to eliminate interference on the air interface signal, for example, by subtracting the coupled signal from the air interface signal, which effectively removes the forward carrier signal from the air interface signal, thereby reducing interference on the reverse transmission signal and enhancing the receiver sensitivity of the reader 110.

In an optional embodiment of the present disclosure, when the reader 110 utilizes the coupled signal to perform interference cancellation on the air interface signal received by the air through the following steps. The coupled signal can be modulated in a stepwise manner to obtain a modulated signal, this modulation can incrementally adjust the amplitude and/or phase of the coupled signal. Next, the air interface signal and the modulated signal can be subtracted to generate a combined signal, then a power of the combined signal is measured, and the power is compared with a preset power threshold. If the power of the combined signal is below the power threshold, it indicates that the cancellation effect has converged, confirming that the interference cancellation is completed. Once convergence is confirmed, the reader 110 demodulates the combined signal to extract information such as product codes, sensor data, environmental data, etc. transmitted by the RFID tag 150. If the power of the current combined signal is greater than or equal to the power threshold, the coupled signal is modulated again in a stepwise manner to generate a new modulated signal, and then the new modulated signal is subtracted from the air interface signal to generate a new combined signal. The power of this new combined signal is measured and compared with the power threshold. The above processes are repeated until the power of the combined signal is below the power threshold; indicating that the interference cancellation is completed. Once the power of the combined signal is below the power threshold, the reader 110 demodulates the combined signal to extract the information sent by the RFID tag 150.

It should be noted that step modulation is a commonly used method for signal modulation. For brevity, specific processes of stepwise modulation is not elaborated upon in this disclosure.

In an optional embodiment of the present disclosure, the host computer 160 can also be used to manage the networking parameters of the reader 110 and to manage the networking parameters of the RF exciter 130 through the reader 110.

Exemplarily, the networking parameters of the reader 110 and the RF exciter 130 managed by the host computer 160 can include, but are not limited to, the physical layer configuration parameters of the reader 110 and the RF exciter 130, including frequency point, bandwidth, coding method, forward link message, inventory mode (cached mode or real-time mode), RF exciter transmit power, synchronization mode, and the like.

In the embodiment of the present disclosure, in the case where the host computer 160 manages the networking parameters of the reader 110, it transmits configuration information about the networking parameters of the reader 110 to the reader 110. The reader 110 then configures the networking parameters based on the received configuration information about the networking parameters. When the host computer 160 manages the networking parameters of the RF exciter(s) 130, the host computer 160 transmits configuration information about the networking parameters of the RF exciter(s) 130 to the reader 110, and the reader 110 then forwards the configuration information about the networking parameters to each RF exciter 130 within the coverage area of the reader 110. Each RF exciter 130 subsequently configures its own networking parameters based on the received configuration information about the networking parameters.

It should be noted that in embodiments of the present disclosure, the reader(s) 110 that communicate with the host computer 160 can be either a single unit or multiple units. The host computer 160 is capable of simultaneously managing multiple readers 110. FIG. 1 merely illustrates an example where the host computer 160 is connected to a single reader 110 for explanatory purposes and should not be construed as a limitation of this disclosure.

In the embodiment of the present disclosure, by establishing a communication connection between the host computer and the readers, the host computer can simultaneously configure the networking parameters of multiple readers, enabling rapid deployment of the radio frequency identification system. Multiple readers can be connected to multiple RF exciters to identify numerous RFID tags, achieving continuous coverage across the deployment area and efficiently identifying a large number of information carried by the RFID tags.

In an optional embodiment of the present disclosure, there are multiple readers 110, and the multiple readers 110 share one network switching device. RF exciters 130 managed by different readers 110 are isolated by a port-based Virtual Local Area Network (VLAN).

In the embodiment of the present disclosure, the first communication device 120 can contain at least one network switching device. In a case where the host computer 160 manages multiple readers 110, these readers 110 can either share one network switching device, or be grouped to use multiple network switching devices. If multiple readers 110 share one network switching device, each reader 110 and its associated RF exciters 130 connect through the same network switch within the first communication device 120. In order to improve network security, RF exciters 130 managed by different readers 110 are isolated by the port-based VLAN, and all RF exciters 130 managed by the same reader 110 are maintained in the same network segment, where the network switching device is responsible for adding and removing VLAN tags identification to ensure proper segmentation and isolation of traffic between different readers 110 and their respective RF exciters 130.

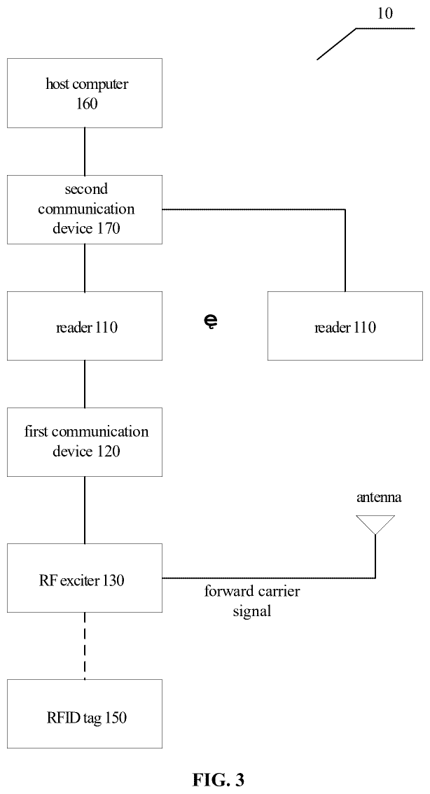

In an optional embodiment of the present disclosure, on the basis of the embodiment shown in FIG. 1, as shown in FIG. 3, the radio frequency identification system 10 can also include a second communication device 170, where the host computer 160 communicates with the reader 110 via the second communication device 170.

Exemplarily, the second communication device 170 can be a network switching device, a WiFi device, a RF communication device, or any other type of communication equipment. The present disclosure does not impose specific restrictions on the form of the second communication device. In a case where the second communication device 170 is a network switching device, the host computer 160 and the reader 110 are connected through a network port of the network switching device, and each reader 110's IP address is managed by the host computer 160.

In the embodiment of the present disclosure, as shown in FIG. 3, the host computer 160 can connect with and manage multiple readers 110 through the second communication device 170. Through the second communication device 170, the host computer 160 can exchange control messages with the multiple readers 110. Only one of the readers 110 is shown in FIG. 3 connected to the first communication device 120; the connection structures for other readers 110 are similar. These readers can also connect to their respective RF exciters through other first communication devices within their coverage areas, though these connections are not detailed in FIG. 3.

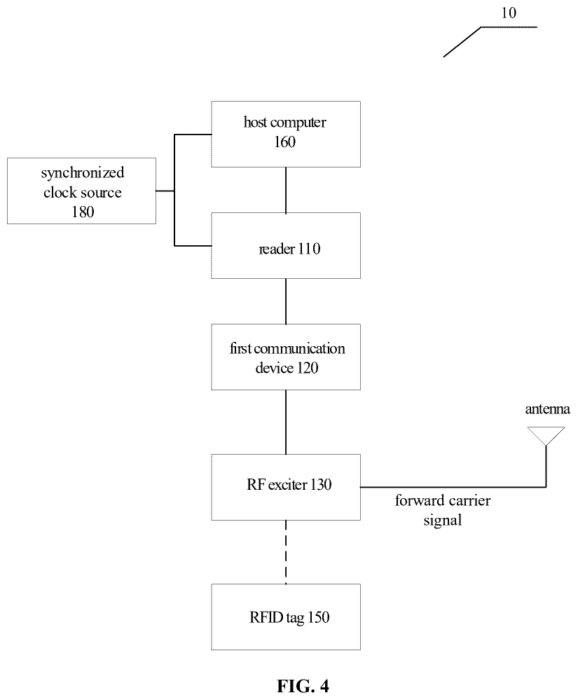

In an optional embodiment of the present disclosure, the radio frequency identification system provided by the present disclosure can also include a synchronized clock source, which broadcasts a clock reference signal to all network units within the radio frequency identification system. As shown in FIG. 4, based on the embodiment shown in FIG. 1, the radio frequency identification system 10 can further include a synchronized clock source 180 that sends a clock reference signal to the host computer 160 and the reader 110. The reader 110 then forward the clock reference signal to the RF exciter 130 through the first communication device 120. Upon receiving the clock reference signal, network units such as the host computer 160, the reader 110 and the RF exciter 130 can carry out standard clock recovery based on the clock reference signal, so as to ensure clock synchronization of all network units in the radio frequency identification system.

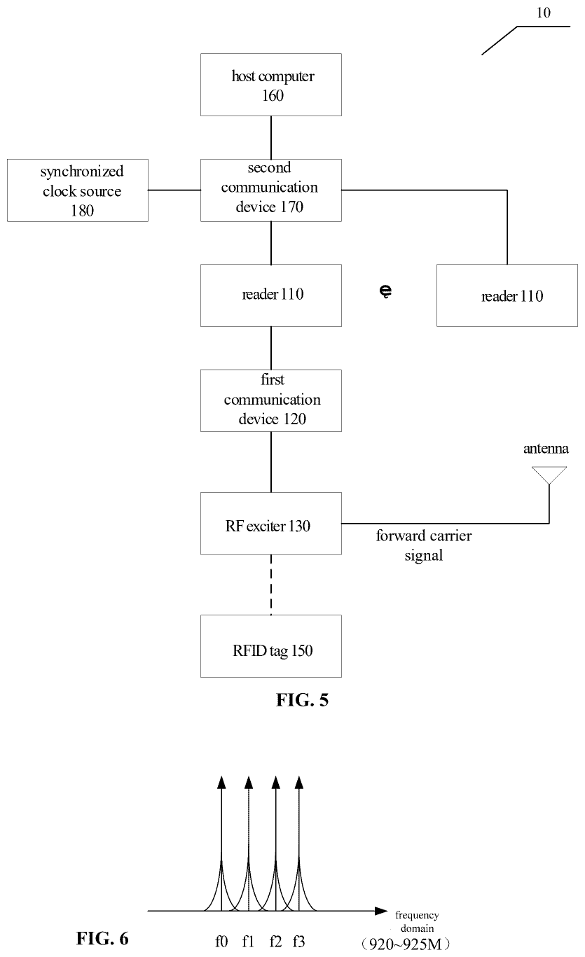

Furthermore, in an optional embodiment of the present disclosure, based on the embodiment shown in FIG. 4, as shown in FIG. 5, the radio frequency identification system 10 can further include a second communication device 170. The host computer 160 communicates with the readers 110 via the second communication device 170, and the synchronization clock source 180 is also connected to the second communication device 170.

In an embodiment of the present disclosure, the synchronized clock source 180 can broadcast a clock reference signal to all network units in the radio frequency identification system, including the readers 110, the host computer 160, the RF exciter 130, and the like. Specifically, the synchronized clock source 180 can transmit the clock reference signal to the host computer 160 and the readers 110 via the second communication device 170. After receiving the clock reference signal, in addition to performing a standard clock recovery based on the clock reference signal, each reader 110 then forwards the clock reference signal to RF exciter(s) 130 within coverage area of the each reader 110 via the first communication device 120. After receiving the clock reference signal, the network units such as the host computer 160, the readers 110 and the RF exciters 130 can perform the standard clock recovery based on the clock reference signal to ensure clock synchronization across all network units in the radio frequency identification system. This ensures that different RF exciters 130 connected to the same reader 110 operate at the same frequency for sending forward carrier signals, preventing interference in the received signals at the reader 110 due to frequency difference between the RF exciters 130.

In practical application scenarios, multiple RF exciters 130 are usually connected to one reader 110 within its coverage. If the multiple RF exciters 130 transmit forward carrier signals simultaneously, interference can occur among the forward carrier signals from RF exciters 130. In order to avoid interference among the forward carrier signals, it is necessary to control the respective RF exciters 130 to transmit the forward carrier signals at different times, ensuring that only one RF exciter 130 transmits the forward carrier signals at any given moment; however, transmitting the forward carrier signals in time-division manner may inevitably reduce the utilization of frequency domain resources. To address this problem, in an optional embodiment of the present disclosure, for multiple RF exciters 130 connected to the same reader 110, the multiple RF exciters 130 transmit forward carrier signals simultaneously but any two of the RF exciters 130 transmit forward carrier signals at different frequencies.

Exemplarily, supposing that four RF exciters are connected under one reader, the four RF exciters transmit forward carrier signals simultaneously, and frequencies of the forward carrier signals respectively transmitted by the four RF exciters are f0, f1, f2, and f3, as shown in FIG. 6. That is to say, each RF exciter transmits a forward carrier signal at a fixed frequency, and the frequencies of the forward carrier signals transmitted by different RF exciters are distinct.

In the embodiment of the present disclosure, different RF exciters connected under the same reader transmit forward carrier signals simultaneously but at distinct frequencies. By transmitting forward carrier signals concurrently at different frequencies, it enhances the reader's inventory efficiency of RFID tags. By transmitting forward carrier signals at different frequencies, it avoids interference among the forward carrier signals, and helps to eliminate the interference on receiving reverse transmission signals from the RFID tags by the reader caused by power leakage when different RF exciters asynchronously transmit forward carrier signals.

In an optional embodiment of the present disclosure, the forward carrier signal transmitted from the reader 110 to the RF exciter 130 operates at a power level referred to as a first power, which can be relatively low. In order to ensure that the forward carrier signal successfully wakes up the RFID tag 150, before transmitting the forward carrier signal, the RF exciter 130 can amplify the power of the forward carrier signal to generate a forward carrier signal with a second power, which is greater than the first power. The RF exciter 130 then transmits the amplified forward carrier signal of the second power through the air interface.

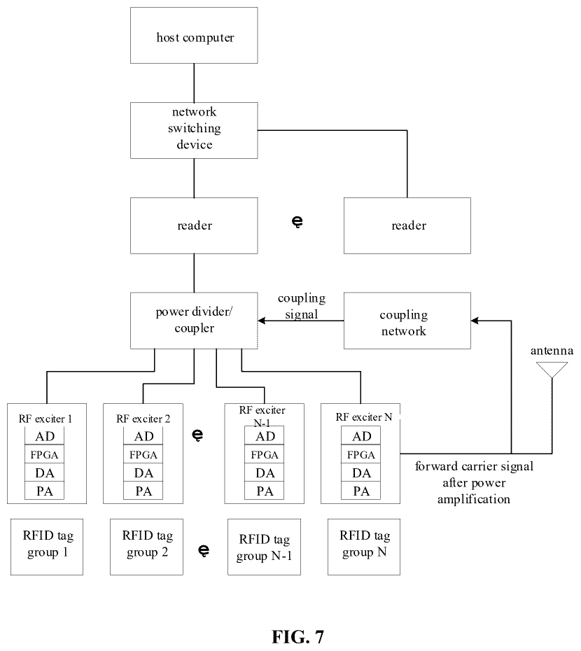

FIG. 7 is a schematic structural diagram of a radio frequency identification system according to a specific embodiment of the present disclosure. As shown in FIG. 7, the radio frequency identification system includes a host computer, a network switching device, multiple readers, a power divider/coupler, a coupling network, multiple RF exciters and multiple groups of RFID tag, where each group can include multiple RFID tags. The host computer connects to and communicates with the multiple readers through the network switching device, and is mainly for managing one or more readers and one or more RF exciters in the network and collecting and processing information related to RFID tags in the system. A reader can connect to multiple RF exciters through the power divider/coupler. The reader primarily manages one or more RF exciters within its coverage area and processes reverse transmission signals transmitted by RFID tags in the system. The power divider/coupler enables the transmission of forward carrier signals, clock reference signals, broadcast messages, and other data based on RF signals. It also facilitates the reception of access request messages and acknowledgement messages replied by RF exciters based on RF signals, coupled signals generated by the coupling network, and the like. The RF exciters transmit forward carrier signals through the air interface to power and communicate with the RFID tags. After waking up the RFID tags, the RF exciter then continues to transmit forward carrier signals to enable RFID tags to modulate and generate reverse transmission signals based on these signals. The RF exciter also supports the function of parsing broadcast messages received from the reader, including parsing based on RF signals to extract networking parameters, where the networking parameters include frequency point, bandwidth, coding method, RF exciter transmit power, synchronization mode, etc. The RF exciter then forwards access request messages and acknowledgement messages back to the reader through RF signals.

As shown in FIG. 7, the RF exciter is equipped with an Analog-to-Digital converter (AD), a Field Programmable Gate Array (FPGA), a Digital-to-Analog converter (DA) and a Power Amplifier (PA). Before transmitting the forward carrier signal, the RF exciter performs the following steps. The AD converts the forward carrier signal into a digital signal. The FPGA processes the digital signal by performing digital demodulation. The demodulated digital signal is then converted back to an analog signal by the DA. The resulting analog signal is amplified by the PA to generate a power-amplified forward carrier signal. On one hand, the power-amplified forward carrier signal is transmitted through the air interface; on the other hand, the power-amplified forward carrier signal enters the coupling network for being coupled to generate the coupled signal, Then the coupled signal is transmitted to the reader through the power divider/coupler, to enable the reader to make use of the coupled signal for interference cancellation. By implementing the aforementioned process, the RF exciter can reduce the interference on the reverse transmission signal received by the reader caused by the forward carrier signal transmitted by the RF exciter through the air interface, thereby improving the reception sensitivity of the reader, and thus enhancing the inventory success rate of RFID tags.

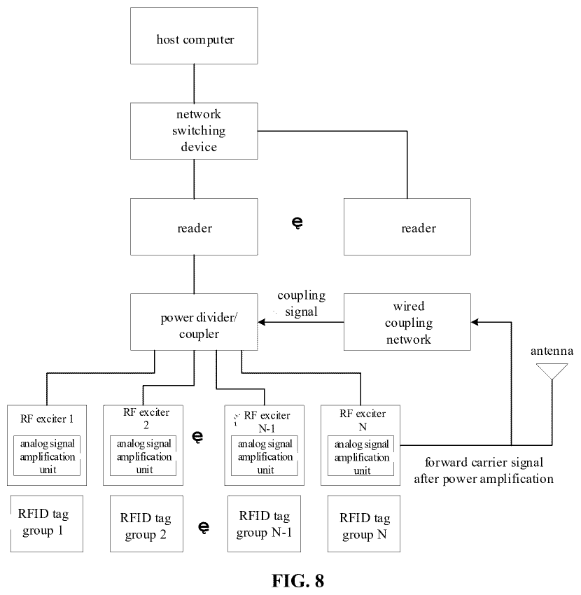

FIG. 8 is schematic structural diagram of an radio frequency identification system in another specific embodiment of the present disclosure. As shown in FIG. 8, the radio frequency identification system includes a host computer, a network switching device, multiple readers, a power divider/coupler, a wired coupling network, multiple RF exciters and multiple groups of RFID tags, where each group of RFID tags can include multiple RFID tags. It should be noted that the roles of respective network units in this implementation are identical to those in the embodiment shown in FIG. 7, and thus will not be repeated here for brevity. As shown in FIG. 8, the RF exciter includes an analog signal amplification unit. Before transmitting the forward carrier signal, the RF exciter first amplifies the power of the forward carrier signal using this unit. The power-amplified signal then serves two key functions: it is transmitted over the air interface to activate and communicate with RFID tags; and, it enters the wired coupling network for being coupled to generate a coupled signal, and then the coupled signal is transmitted to the reader through the power divider/coupler, to enable the reader to utilize the coupled signal for interference cancellation. In this embodiment, using the wired coupling network to generate the coupled signal offers significant advantages over wireless coupling. Since signals experience less loss during wired transmission compared to wireless transmission, and wired transmission avoids interference from other air interface signals, the coupled signal received by the reader has superior quality. This improves the effectiveness of interference cancellation, enhances the reader's reception sensitivity, and ultimately increases the inventory success rate of RFID tags.

The RFID system according to the embodiments of the present disclosure can be rapidly deployed in complex industry application scenarios, enabling efficient identification of vast amounts of information carried by passive tags. It is suitable for applications in Ultra-High Frequency(UHF) RFID, passive Internet of Things (IoT), and mobile communications fields.

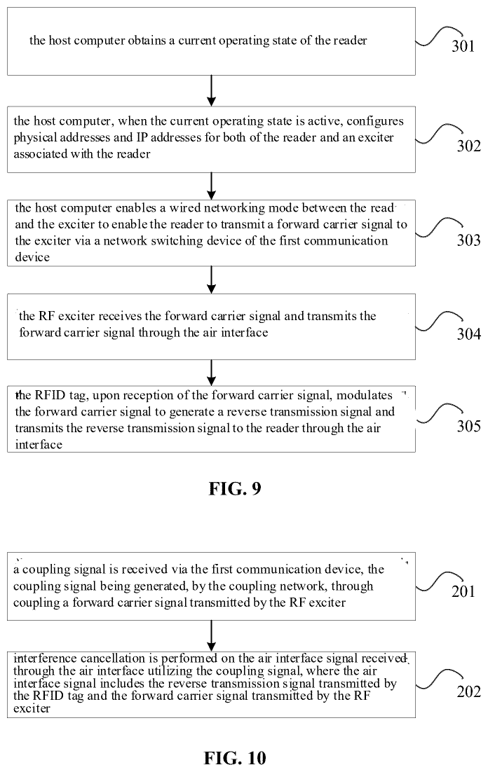

In order to achieve the above embodiments, the present disclosure further provides a signal processing method applied to the RFID system described in the previous embodiments. The radio frequency identification system at least includes a host computer, a reader, a first communication device, an RF exciter, and an RFID tag. The reader and the RF exciter perform information interaction with each other via the first communication device. FIG. 9 is a schematic flowchart of the signal processing method according to an embodiment of the present disclosure. As shown in FIG. 9, the signal processing method can include the following steps.

Step 301, the host computer obtains a current working state of the reader.

In the embodiment of the present disclosure, the host computer communicates with the reader in the RFID system, and the host computer can obtain the current working states of the reader's network interface card.

The network interface card have two states: active and inactive. The current working state obtained by the host computer is either the active or inactive state.

Step 302, when the current working state is active, the host computer configures physical addresses and IP addresses for both the reader and its associated RF exciter.

In the embodiment of the present disclosure, if the current working state obtained by the host computer is active, the host computer can further configure the physical (MAC) address and IP address of the reader, and configure the MAC address and IP address of the RF exciter associated with the reader, to enable wired network communication between the reader and the RF exciter.

Step 303, the host computer enables a wired networking mode between the reader and the RF exciter to enable the reader to transmit a forward carrier signal to the RF exciter via a network switching device of the first communication device.

In the embodiment of the present disclosure, in a case where the current working state obtained by the host computer is active, the host computer not only configures the MAC addresses and the IP addresses, but also enables the wired networking mode between the reader and the RF exciter. Then, the wired networking between the reader and the associated RF exciter can be carried out through the network switching device of the first communication device, and the reader transmits the forward carrier signal to the RF exciter through the wired network provided by the network switching device.

Furthermore, if the current operating status is inactive, the host computer can enable a wireless networking mode between the reader and the RF exciter.

In the embodiment of the present disclosure, in a case where the current working state obtained by the upper computer is inactive, it indicates that the network interface card of the reader is unavailable, the host computer can enable the wireless networking mode between the reader and the RF exciter, so as to enable wireless networking between the reader and the associated RF exciter, and the reader transmits the forward carrier signal to the RF exciter through a wireless network (e.g., by using radio frequency signals).

Step 304, the RF exciter receives the forward carrier signal and transmits the forward carrier signal through the air interface.

Step 305, the RFID tag, in response to receiving the forward carrier signal, modulates the forward carrier signal to generate a reverse transmission signal and transmits it back to the reader through the air interface.

Specifically, the forward carrier signal can be received by the reader, and also can be received by the RFID tag. The RFID tag, in response to receiving the forward carrier signal, can modulate the forward carrier signal to generate a reverse transmission signal, and then transmits it back to the reader through the air interface. This process completes the signal processing for both a transmission link and an reception link in the radio frequency identification system.

The signal processing method according to the embodiment of the present disclosure, the host computer acquires the current working state of the reader. If the current working state is active, the host computer configures the physical addresses and the IP addresses of the reader and an RF exciter associated with the reader, and also enables the wired networking mode between the reader and the RF exciter. This allows the reader to transmit the forward carrier signal to the RF exciter through the network switching device of the first communication device. Conversely, if the current working state is inactive, the host computer enables the wireless networking mode between the reader and the RF exciter. Thus, this method achieves flexible networking between the reader and the RF exciter. In addition, when the reader and the RF exciter communicate through the network switching device, the quality of signal demodulation is significantly superior, compared with the solution of using wireless networking to transmit signals between the reader and the RF exciter. Wired transmission reduces susceptibility to interference from the wireless channel environment. Moreover, this method leverages existing network switching devices in the actual environment for signal transmission between the reader and exciter and minimizes additional deployment costs.

In an optional embodiment of the present disclosure, the aforementioned radio frequency identification system can further include a coupling network for generating coupled signals, so that the reader can utilize coupled signals for interference cancellation on air interface signals, thereby enhancing the reception sensitivity of the reader. As shown in FIG. 10, the signal processing method provided by the present disclosure for the RFID system can further include the following steps.

Step 201, a coupled signal is received via the first communication device, the coupled signal being generated, by the coupling network, through coupling a forward carrier signal transmitted by the RF exciter.

The first communication device can include a power divider and a coupler, or it can further include a network switching device.

As previously described, the RF exciter transmits the forward carrier signal through the air interface, which can be received by both the reader and RFID tags within the wireless coverage area. Upon receiving the forward carrier signal, the RFID tag modulates it to generate a reverse transmission signal. The reverse transmission signal can carry information such as product codes, environmental data, sensing data, etc., and then is sent back to the reader through the air interface. Consequently, the air interface signals received by the reader through the air interface include both the reverse transmission signals from the RFID tags and the forward carrier signal from the RF exciter. In order to eliminate interference from the forward carrier signal in the air interface signals, in the embodiment of the present disclosure, the radio frequency identification system can further include a coupling network. In addition to transmitting the forward carrier signal through the air interface, the RF exciter also transmits the forward carrier signal to the coupling network, the coupling network couples the forward carrier signal to generate the coupled signal, which is then transmitted to the reader through the first communication device connected to the coupling network.

Step 202, the reader utilizes the coupled signal to perform interference cancellation on the air interface signal received through the air interface. These air interface signals include both the reverse transmission signals transmitted by the RFID tags and the forward carrier signals transmitted by the RF exciter.

In the embodiment of the present disclosure, after the reader receives the coupled signal via the first communication device, it can perform interference cancellation on the air interface signals received through the air interface to eliminate the forward carrier signal present in the air interface signal.

For example, the reader can subtract the coupled signal from the air interface signal to achieve the purpose of eliminating interference, specifically removing the forward carrier signal component present in the air interface signal.

In the embodiment of the present disclosure, the coupling network in the radio frequency identification system is designed to generate a coupled signal based on the forward carrier signal. The reader utilizes the coupled signal to perform interference cancellation on the air interface signal received through the air interface, effectively eliminating the forward carrier signal in the air interface signal that interferes with the reverse transmission signal from the RFID tag. Hence, by reducing the uplink reception interference power, the reader's receiver sensitivity is significantly enhanced. Consequently, the working distance of the RFID system is increased, thereby expanding its coverage area.

In an optional embodiment of the present disclosure, when the reader utilizes the coupled signal to perform interference cancellation on the air interface signal received through the air interface, the reader follows these steps. The reader modulates the coupled signal in a stepwise manner to obtain a modulated signal, and the modulated signal is subtracted from the air interface signal to generate a combined signal. A power of the combined signal is measured, and in a case where the power of the combined signal is below a predefined power threshold, the reader determines that interference cancellation is completed. Once interference cancellation is confirmed, the reader is demodulates the combined signal to extract and identify the information carried by the reverse transmission signal, such as product codes, sensing data, environmental data, etc.

The predefined power threshold can be set according to the actual requirements, and the present disclosure does not restrict specific value of the power threshold.

In the embodiment of the present disclosure, the power of the currently generated combined signal is compared with the power threshold. If the power of the currently generated combined signal is greater than or equal to the power threshold, the coupled signal is modulated again in the stepwise manner to generate a new modulated signal. The new modulated signal is then subtracted from the air interface signal to generate a new combined signal. The power of the new combined signal is measured and compared with the power threshold. If the power of the new combined signal is still greater than or equal to the power threshold, the above processes are repeated until the power of a generated combined signal falls below the power threshold, then it is determined that the interference cancellation is completed and the current combined signal is demodulated.

In the embodiment of the present disclosure, the reader performs interference cancellation on the received air interface signals to reduce their powers below the power threshold. This process minimizes the interference on receiving the reverse transmission signal from RFID tags caused by the forward carrier signal transmitted by the RF exciter, thereby enhancing the sensitivity performance of the reader and improving the inventory success rate of RFID tags by the reader.

An embodiment of the present disclosure further provides a computer-readable storage medium. The computer-readable storage medium stores computer-executable instructions that, when executed by a processor, implement the steps of the methods described in the aforementioned embodiments. To avoid redundancy, detailed descriptions of these implementations are omitted here.

An embodiment of the present disclosure further provides a computer program product. The computer program product includes a computer program that, when executed by a processor, implements the steps of the methods described in the aforementioned embodiments. To avoid redundancy, detailed descriptions of these implementations are omitted here.

1. A radio frequency identification system, comprising a host computer, a reader, a first communication device, a radio frequency (RF) exciter, and a radio frequency identification (RFID) tag, the host computer communicating with the reader, the reader and the RF exciter performing information interaction via the first communication device;
wherein the host computer is configured to: obtain a current working state of the reader, and when the current working state is active, configure physical addresses and IP addresses for both of the reader and the RF exciter and enable a wired networking mode between the reader and the RF exciter;
the reader is configured to transmit a forward carrier signal to the RF exciter via a network switching device of the first communication device upon enablement of the wired networking mode;
the RF exciter is configured to transmit the forward carrier signal through the air interface;
and the RFID tag is configured to modulate the forward carrier signal to generate a reverse transmission signal upon reception of the forward carrier signal and transmit the reverse transmission signal to the reader through the air interface.

2. The radio frequency identification system according to claim 1, wherein
the host computer is further configured to enable a wireless networking mode between the reader and the RF exciter when the current working state is inactive; and
the reader is further configured to transmit a forward carrier signal to the RF exciter through a power divider and a coupler of the first communication device upon enablement of the wireless networking mode.

3. The radio frequency identification system according to claim 2, further comprising a coupling network; wherein
the RF exciter is further configured to transmit the forward carrier signal to the coupling network;
the coupling network, connected to the first communication device, is configured to couple the forward carrier signal to generate a coupled signal and transmit the coupled signal to the reader through the power divider and the coupler of the first communication device; and
the reader is further configured to utilize the coupled signal to perform interference cancellation on an air interface signal received through the air interface, the air interface signal comprising the reverse transmission signal and the forward carrier signal.

4. The radio frequency identification system according to claim 3, wherein the reader is further configured to:
modulate the coupled signal in a stepwise manner to obtain a modulated signal;
subtract the modulated signal from the air interface signal to generate a combined signal;
determine that interference cancellation is completed in a case where a power of the combined signal is below a power threshold, and demodulate the combined signal.

5. The radio frequency identification system according to claim 1, wherein there are a plurality of readers, the plurality of readers share one network switching device, and RF exciters managed by different readers are isolated by a port-based Virtual Local Area Network.

6. The radio frequency identification system according to claim 1, further comprising a synchronized clock source;
wherein the synchronized clock source is configured to transmit a clock reference signal to the host computer and the reader, and the reader is further configured to transmit the clock reference signal to the RF exciter via the first communication device.

7. The radio frequency identification system according to claim 6, further comprising a second communication device, the host computer communicating with the reader via the second communication device;
wherein the synchronized clock source is connected to the second communication device, and is configured to transmit the clock reference signal to the host computer and the reader via the second communication device.

8. The radio frequency identification system according to claim 6, wherein a plurality of RF exciters are connected under an identical reader, the plurality of RF exciters transmit forward carrier signals simultaneously, and any two of the plurality of RF exciters transmit forward carrier signals of distinct frequencies.

9. The radio frequency identification system according to claim 1, wherein the power of the forward carrier signal is a first power;
the RF exciter is further configured to amplify the power of the forward carrier signal to generate a forward carrier signal with a second power, and to transmit the forward carrier signal with the second power through the air interface.

10. A signal processing method, applied to a radio frequency identification system wherein the radio frequency identification system comprises a host computer, a reader, a first communication device, a radio frequency (RF) exciter, and a radio frequency identification (RFID) tag,
wherein the host computer communicating with the reader, the reader and the RF exciter performing information interaction via the first communication device;
wherein the signal processing method comprises:
obtaining, by the host computer, the current working state of the reader;
when the current working state is active, configuring, by the host computer, the physical addresses and the IP addresses for both of the reader and an RF exciter associated with the reader;
enabling, by the host computer, a wired networking mode between the reader and the RF exciter,
transmitting, by the reader, upon enablement of the wired networking mode, a forward carrier signal to the RF exciter via the network switching device of the first communication device;
transmitting, by the RF exciter, the forward carrier signal through the air interface; and
upon reception of the forward carrier signal, modulating, by the RFID tag, the forward carrier signal to generate a reverse transmission signal, and
transmitting, by the RFID tag, the reverse transmission signal to the reader through the air interface.

11. A computer-readable storage medium, which stores computer-executable instructions that, when executed by a processor, implement the signal processing method according to claim 10.

12. (canceled)

13. The signal processing method according to claim 10, wherein the method further comprises:
enabling, by the host computer, a wireless networking mode between the reader and the RF exciter when the current working state is inactive; and
transmitting, by the reader, the forward carrier signal to the RF exciter through a power divider and a coupler of the first communication device upon enablement of the wireless networking mode.

14. The signal processing method according to claim 13, wherein the method further comprises: the radio frequency identification system further comprises a coupling network;
transmitting, by the RF exciter, the forward carrier signal to the coupling network;
coupling, by the coupling network connected to the first communication device, the forward carrier signal to generate a coupled signal,
transmitting, by the coupling network, the coupled signal to the reader through the power divider and the coupler of the first communication device; and
utilizing, by the reader, the coupled signal to perform interference cancellation on an air interface signal received through the air interface, wherein the air interface signal comprising the reverse transmission signal and the forward carrier signal.

15. The signal processing method according to claim 14, wherein the method further comprises:
modulating, by the reader, the coupled signal in a stepwise manner to obtain a modulated signal;
subtracting, by the reader, the modulated signal from the air interface signal to generate a combined signal;
determining, by the reader, that interference cancellation is completed in a case where a power of the combined signal is below a power threshold, and
demodulating, by the reader, the combined signal upon confirmation of completed interference cancellation.

16. The signal processing method according to claim 10, wherein there are a plurality of readers, the plurality of readers share one network switching device, and RF exciters managed by different readers are isolated by a port-based Virtual Local Area Network.

17. The signal processing method according to claim 10, wherein the radio frequency identification system further comprises a synchronized clock source; wherein the method further comprises:
transmitting, by the synchronized clock source, a clock reference signal to the host computer and the reader, and
transmitting, by the reader, the clock reference signal to the RF exciter via the first communication device.

18. The signal processing method according to claim 17, wherein the radio frequency identification system further comprises a second communication device, the host computer communicating with the reader via the second communication device;
wherein the synchronized clock source is connected to the second communication device,
wherein the method further comprises:
transmitting, by the synchronized clock source, the clock reference signal to the host computer and the reader via the second communication device.

19. The signal processing method according to claim 17, wherein a plurality of RF exciters are connected under an identical reader, the plurality of RF exciters transmit forward carrier signals simultaneously, and any two of the plurality of RF exciters transmit forward carrier signals of distinct frequencies.

20. The signal processing method according to claim 10, wherein the power of the forward carrier signal is a first power; wherein the method further comprises:
amplifying, by the RF exciter, the power of the forward carrier signal to generate a forward carrier signal with a second power, and
transmitting, by the RF exciter, the amplified forward carrier signal with the second power through the air interface.
